(19) United States
(12) Patent Application Publication
(10) Pub. No.: US 2026/0077372 A1
(43) Pub. Date: Mar. 19, 2026

(54) METHOD AND APPARATUS FOR DELIVERING FLUIDS AND/OR GASES USING A DIGITAL CONTROL STRUCTURE

(71) Applicant: JACK IVAN JMAEV, ORANGE, CA (US)

(72) Inventor: FAWAZ SALIM SALEEM, LOMA LINDA, CA (US)

(21) Appl. No.: 18/727,748

(22) PCT Filed: Jul. 11, 2022
(86) PCT No.: PCT/US2022/049738

§ 371 Date: Jul. 10, 2024

(51) Int. Cl. B05B 12/08; B05B 12/14; G05D 7/01

(52) U.S. Cl. CPC B05B 12/087; B05B 12/1418; G05D 7/0113

(57) ABSTRACT

A method and apparatus for controlling fluid flow by receive a first and second fluid into separate pressure equalization chambers that are isolated by diaphragms. The fluid are mixed by allowing them to flow over respective dams into a mixing chamber when their respective diaphragms are deformed. The pressure to the mixing chamber is equalized to ensure proper flow from each fluid stream.

### RELATED APPLCATIONS

The present application claims priority to Patent Cooperation Treaty Application No. PCT/US21/17086, entitled “METHOD AND APPARATUS FOR DELIVERING TEMPERATURE CONTROLLED WATER” by Saleem et al, which was filed on 8 Feb. 2021, the text and drawings of which are incorporated by reference into this application in their entirety; and United Stated Provisional Ser. No. 63/279,044 entitled “METHOD AND APPARATUS FOR DELIVERING TEMPERATURE CONTROLLED WATER USING A DIGITAL CONTROL STRUCTURE” filed on 12 Nov. 2021, the text and drawings of which are incorporated by reference into this application in their entirety.

### BACKGROUND

Modern surgical techniques are highly successful due in no small part to effective control of infection. Controlling infection, in turn, requires sterilization of surgical instruments before an operation takes place. Also, it is important that stray infectious matter is neutralized, or the potential of infection from such stray infectious matter is substantially eliminated. Collectively, all of the techniques used in mitigating the potential for infection are generally referred to as “infection control”.

Most people outside of the medical community realize that is important to sterilize instruments. Also, laypersons appreciate that everyone in the surgical theater is attired in substantially sterile garments and wear gloves that form a protective barrier between the surgeon and the patient. Laypersons also understand that, as a result of fictional depictions in movies and television, the surgeon and other staff entering the surgical theater “scrub up” before putting on their sterilized gloves.

A surgical scrub is performed in order to remove resident and transient microorganisms from the hands. It is also important to inhibit the re-growth of flora for the duration of the surgical procedure. By inhibiting such re-growth, there is an added safety for the patient in the event that the glove is somehow compromised during surgery. In other words, should the glove be torn, or accidentally cut, there is less likelihood of transfer of microbial infection to the patient when flora normally resident on the hands is substantially prevented from multiplying. And, according to the World Health Organization's guidelines for hand hygiene, 35% of all gloves have been punctured after just two hours of surgery. Certainly, there is great motivation in inhibiting regrowth of flora.

Amazingly, what is an effective washing of the hands prior to performing a surgical procedure is still widely debated. For example, there are proponents of antimicrobial surgical scrub solutions. In an ordinary environment, these are typically known as hand sanitizers. Amongst the community of surgical professionals, such surgical scrub solutions are known as handrub formulations. As one might expect, proponents of antimicrobial surgical scrub solutions also include the manufacturers of such products. In general, it is the persisting effect that antimicrobial surgical scrub solutions purportedly offered by such products is a compelling argument for preventing resurgence of flora on a surgeon's hands, especially when the hands are in a warm environment formed between the glove and the skin itself.

As compelling as the arguments may be, most people, including professional hospital practitioners and surgeons, still see the need for a prolonged agitation of the skin under running water. In other words, surgeons do and will continue to prefer aggressive washing of the hands using antibacterial soap and hot running water. Commonly used antisepsis agents include chlorhexidine and povidone-iodine.

In its guidelines for hand hygiene, the World Health Organization (“WHO”) indicates that has previously recommended various hand formulations. It also admits that these handrub formulations, as tested by two independent laboratories, failed to pass antisepsis requirements. Accordingly, the WHO acknowledges that further research is necessary because there is still not enough information or antidotal data regarding the use of the handrub formulations that it itself has recommended. So, the use of water and antibacterial soaps and antisepsis agents will continue to be a mainstay of surgical hand preparation.

The proper technique for the use of water and soap in preparing for surgery has also evolved over the years. For example, in 1834, preparation for surgery included three steps. First, the hands were to be washed with hot water and medicated soap for at least five minutes. Then, a 90% ethanol solution was to be applied for a period of 3 to 5 minutes and finally, the hands are to be rinsed with an antiseptic liquid. In 1939, a seven-minute hand wash with soap and water was to be followed by a 70% ethanol mixture for three minutes, but after drying the hands with a towel. Today, most healthcare institutions require a five-minute handwashing regimen. Even still, there is wide variation in the amount of time dedicated to a particular washing practice and even the temperature of the water that must be used.

Surgeons are just as prone to error as any ordinary human being. However, when ordinary people fail to wash their hands properly, patients are not placed at risk. However, should a surgeon be distracted during “scrubbing”, a patient stands the risk of severe infection as a result of what would ordinarily be a simple surgical procedure.

And, it is also interesting to appreciate that the exact technique for handwashing can vary based on the type and duration of surgical procedure intended.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for controlling the flow of fluid;

FIG. 2 is a flow diagram that depicts one alternative example method for controlling the flow of fluid;

FIG. 3 is a flow diagram that depicts alternative example method that facilitates mixing a second fluid with the first fluid;

FIG. 4 is a flow diagram that depicts an alternative method for mixing two fluids together;

FIG. 5 is a flow diagram that depicts one alternative example method for allowing fluid still over a first, first-chamber-down;

FIG. 6 is a flow diagram that depicts one alternative example method for applying a magnetic field to the striker;

FIG. 7 is a flow diagram that depicts yet another alternative method for allowing fluid to flow over a first, first-chamber-dam;

FIG. 8 is a flow diagram that depicts yet another alternative example method for align fluid to flow over a first, first-chamber-dam;

FIG. 9. is a flow diagram for additional method steps included in this alternative example embodiment to ensure of fluid arriving at a first chamber and fluid arriving at a second chamber are of substantially equal pressure;

FIG. 10 is a perspective cutaway view of a device for controlling the flow of fluid;

FIG. 11 is a top sectional view of a device for controlling the flow of fluid.

FIG. 12 is a perspective cutaway view of the device for controlling the flow of fluid;

FIG. 13 is a pictorial diagram that illustrates the sizing of the various ports which allow flow from an input chamber into the mixing chamber;

FIG. 14 is a pictorial diagram that further illustrates the structure of a pressure equalization cavity relative to an input chamber; and

FIG. 15 is a cutaway view of a pressure equalization device included in one alternative example embodiment of the device for controlling the flow of fluid.

### DETAILED DESCRIPTION

In the interest of clarity, several example alternative methods are described in plain language. Such plain language descriptions of the various steps included in a particular method allow for easier comprehension and a more fluid description of a claimed method and its application. Accordingly, specific method steps are identified by the term “step” followed by a numeric reference to a flow diagram presented in the figures, e.g. (step 5). All such method “steps” are intended to be included in an open-ended enumeration of steps included in a particular claimed method. For example, the phrase “according to this example method, the item is processed using A” is to be given the meaning of “the present method includes step A, which is used to process the item”. All variations of such natural language descriptions of method steps are to be afforded this same open-ended enumeration of a step included in a particular claimed method.

Unless specifically taught to the contrary, method steps are interchangeable and specific sequences may be varied according to various alternatives contemplated. Accordingly, the claims are to be construed within such structure. Further, unless specifically taught to the contrary, method steps that include the phrase “...comprises at least one or more of A, B, and/or C...” means that the method step is to include every combination and permutation of the enumerated elements such as “only A”, “only B”, “only C”, “A and B, but not C”, “B and C, but not A”, “A and C, but not B”, and “A and B and C”. This same claim structure is also intended to be open-ended and any such combination of the enumerated elements together with a non-enumerated element, e.g. “A and D, but not B and not C”, is to fall within the scope of the claim. Given the open-ended intent of this claim language, the addition of a second element, including an additional of an enumerated element such as “2 of A”, is to be included in the scope of such claim. This same intended claim structure is also applicable to apparatus and system claims.

In many cases, description of various alternative example methods is augmented with illustrative use cases. Description of how a method is applied in a particular illustrative use case is intended to clarify how a particular method relates to physical implementations thereof. Such illustrative use cases are not intended to limit the scope of the claims appended hereto.

As illustrated in the first incorporated reference, controlling temperature of water through a mixing chamber was accomplished through the use of graduated valves. Although graduated valves can easily accomplish mixing water to obtain a particular temperature and flow rate for delivery, control of such graduated valves requires, in many cases, requires rotary actuators. Yet other forms of graduated valves operate on a linear basis, such linear valves, which are also known as proportional valves, require sophisticated electronics to manage the position of a piston within a cylinder. All of these control mechanisms necessary to manipulate graduated valves are inherently susceptible to inaccuracies and failures.

The second incorporated reference describes a mechanism where discrete digital valves are used to control the flow rate of water into a mixing chamber from two discrete sources. It should be evident through the disclosures presented in the second incorporated reference and within the body of this application that a similar structure of discrete digital valves is used to control the flow of at least one or more of a gas and/or a liquid. For example, the present method and apparatus are used to control gases such as oxygen, nitrogen and the like and/or petroleum products and other various types of oils. In fact, the present method and apparatus is used to control various forms of a gas and/or a liquid and any examples presented herein are not intended to limit the scope of the claims appended hereto. Consistent with its ordinary meaning, the term “fluid” shall include at least one or more of a gas and/or a liquid.

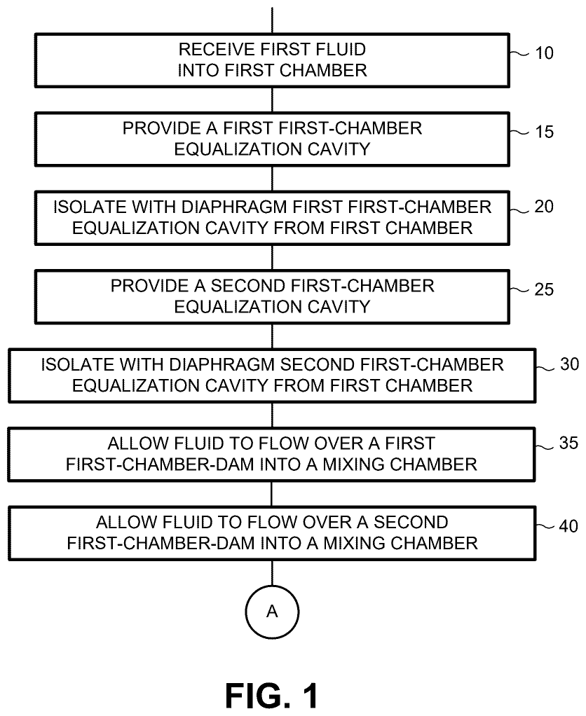

FIG. 1 is a flow diagram that depicts one example method for controlling the flow of fluid. This example method comprises a first step of receiving a first fluid into a first chamber (step 10). The first, first-chamber equalization cavity is provided (step 15). In this example method, the first, first-chamber equalization cavity is formed by isolating the first chamber from the first, first-chamber equalization cavity by means of a first diaphragm (step 20).

This example method further comprises a step providing a second, first-chamber equalization cavity (step 25), which is accomplished in another included step for isolating with a second diaphragm the second, first-chamber equalization cavity from the first chamber (step 30). This example method includes steps for allowing fluid to flow over a first first-chamber-dam into a mixing chamber (step 35) and also allowing fluid to flow over a second first-chamber-dam into said mixing chamber (step 40).

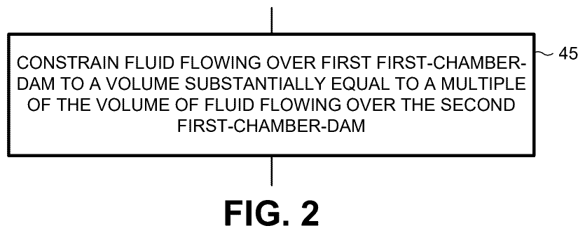

FIG. 2 is a flow diagram that depicts one alternative example method for controlling the flow of fluid. In this alternative example method, the step is provided for constraining the flow fluid over the first, first-chamber-dam to a volume substantially equal to a multiple of the volume of fluid flowing over the second, first-chamber-dam (step 45). In some alternative methods, the multiple includes a binary multiple so as to create a substantially digital control of fluid flow by enabling the flow over one of a plurality of first-chamber-dams.

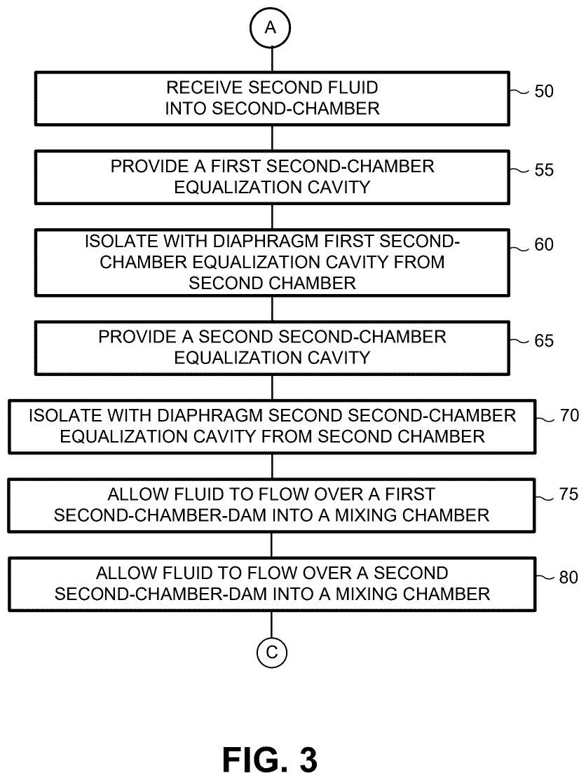

FIG. 3 is a flow diagram that depicts alternative example method that facilitates mixing a second fluid with the first fluid. In this alternative example method, the second fluid is received into a second chamber (step 50) in a first included step. This alternative example method further includes steps for providing a first, second-chamber equalization cavity (step 55) and the step four isolating the first, second-chamber equalization cavity from the second chamber by means of a third diaphragm (step 60).

This alternative example method further includes a step for providing a second, second-chamber equalization cavity (step 65) and a step four isolating with a fourth diaphragm the second, second-chamber equalization cavity from the second chamber (step 70). This alternative example method further includes a step for allowing fluid to flow over a first, second-chamber-dam into the mixing chamber (step 75). An additional method step is included for align fluid to flow over a second, second-chamber-dam into the mixing chamber (step 80).

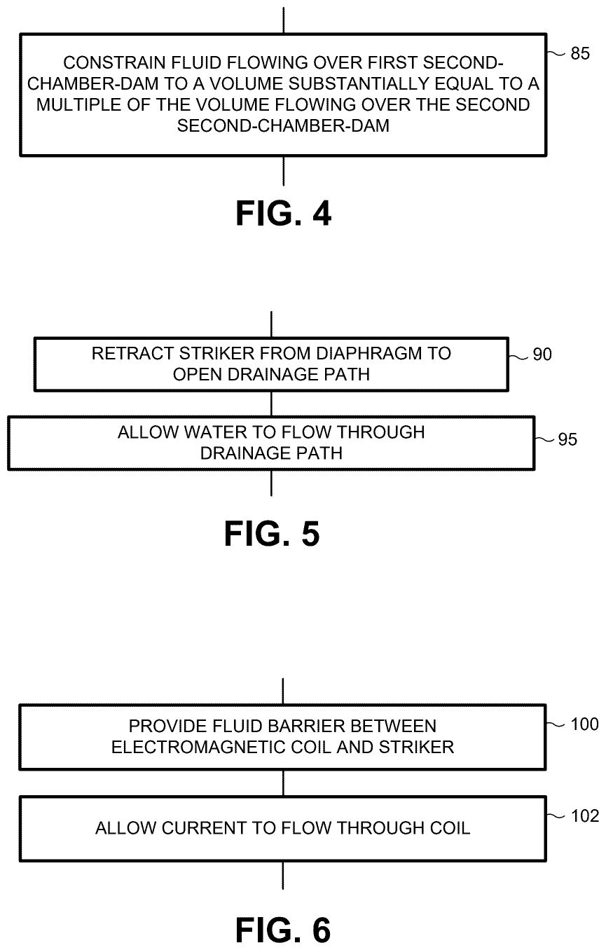

FIG. 4 is a flow diagram that depicts an alternative method for mixing two fluids together. In this alternative example method, a step is included for constraining the flow of fluid over a first, second-chamber-dam to a volume substantially equal to a multiple of the volume of fluid flowing over the second, second-chamber-dam (step 85). In yet another alternative example method, the multiple comprises a substantially binary multiple to enable a substantially digital control of the amount of second fluid flowing into the mixing chamber.

FIG. 5 is a flow diagram that depicts one alternative example method for allowing fluid still over a first, first-chamber-down. In this alternative example method, a first included step provides for applying a magnetic field to retract the striker that is covering a drainage that from the first, first-chamber equalization path to the mixing chamber and then additional step for allowing fluid to flow through the drainage fast from the first, first-chamber equalization cavity to the mixing chamber when said striker is retracted.

FIG. 6 is a flow diagram that depicts one alternative example method for applying a magnetic field to the striker. In this alternative example method, and included method step provides for providing a fluid barrier between the electromagnetic coil and the striker (step 100) and then allowing the electrical current to flow through the electromagnetic coil (step 102).

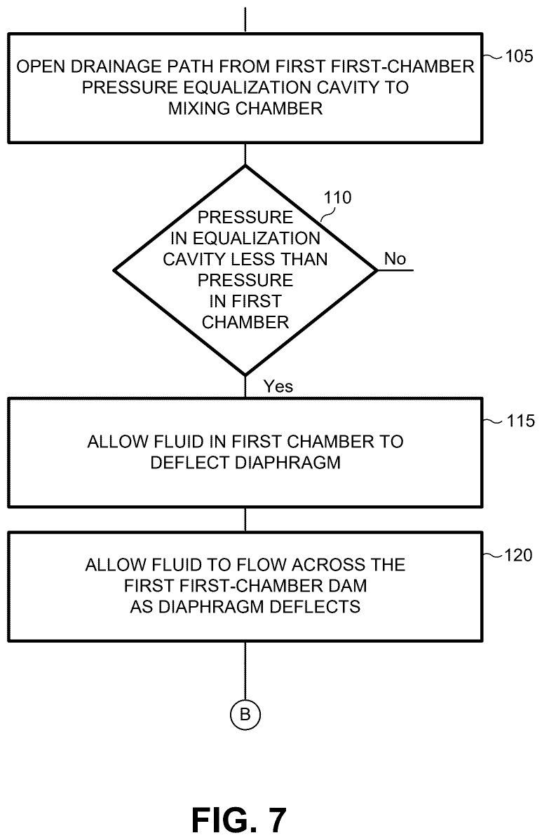

FIG. 7 is a flow diagram that depicts yet another alternative method for allowing fluid to flow over a first, first-chamber-dam. This alternative example method includes a step for opening a drainage path from the first, first-chamber pressure equalization cavity to the mixing chamber (step 105). As fluid flows from the first, first-chamber pressure equalization cavity into the mixing chamber the pressure of the fluid in the equalization cavity will drop below that of the pressure of fluid in the first chamber. When this occurs, as depicted in the included step 110, fluid in the first chamber will be able to deflect the diaphragm (step 115) in an additional included step followed by an additional includes step wherein fluid from the first chamber is allowed to flow across the first, first-chamber-dam as the diaphragm deflects (step 120).

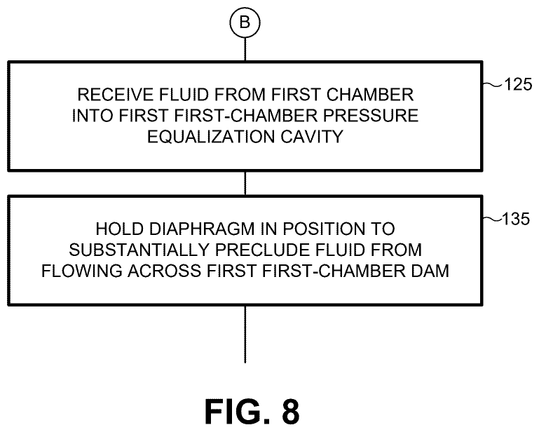

FIG. 8 is a flow diagram that depicts yet another alternative example method for align fluid to flow over a first, first-chamber-dam. These additional included method steps provide for discontinuing the flow of fluid across the first, first-chamber-dam by holding the first diaphragm in a position to substantially preclude fluid from flowing across the first, first-chamber dam (step 135) and then allowing fluid from the first chamber to flow into the first, first-chamber pressure equalization cavity (step 125).

Should be appreciated that, according to yet another alternative example method, the rate of flow of fluid from the first-chamber into the first, first-chamber pressure equalization cavity is at a rate so as to reduce the pressure gradient between the first-chamber in the first, first-chamber pressure equalization cavity.

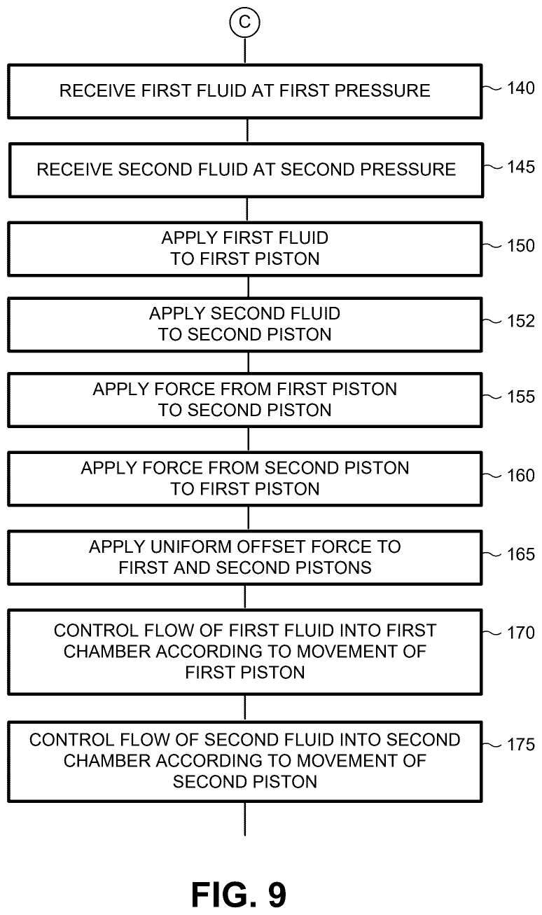

FIG. 9. is a flow diagram for additional method steps included in this alternative example embodiment to ensure of fluid arriving at a first chamber and fluid arriving at a second chamber are of substantially equal pressure. It should be appreciated that, in the event that fluid in the first chamber is at a greater pressure than fluid at the second chamber, proper mixing may not occur as back pressure from the mixing chamber prevents fluid from the chamber having a lower pressure from properly mixing with water contained in the higher pressure chamber.

In order to mitigate such effects, an additional included step is provided for fluid from a first input source at a first pressure (step 140). An additional include step provides for receiving fluid from a second input source at a second pressure (step 145). Additional method steps provide for applying the pressure of the first fluid to a first piston (step 150) and applying the pressure of the second fluid to a second piston (step 155). It should be appreciated that, in these included method steps, the first and second pistons operate in a substantially opposite direction. An additional included step provides for transferring the force from the first piston to the second piston contemporaneously with transferring the force from the second piston to the first piston (step 160, 165). In this alternative example method, a uniform offset to said forces is provided to ensure that the minimum pressure applied to each piston may be maintained.

Once both pistons have an equal pressure applied thereto, control of the flow of the first fluid into the first chamber is controlled according to the first piston position (step 170) and control of the flow of the second fluid into the second chamber is controlled according to the position of the second piston (step 175).

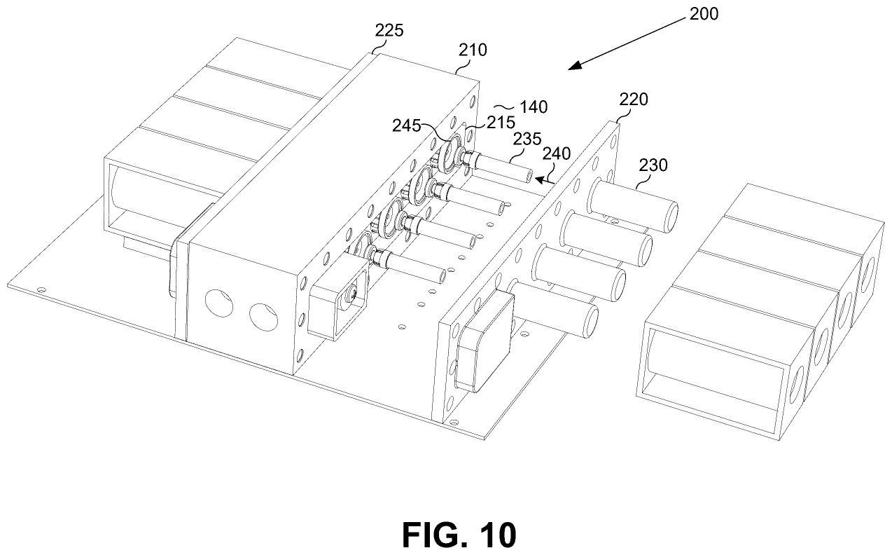

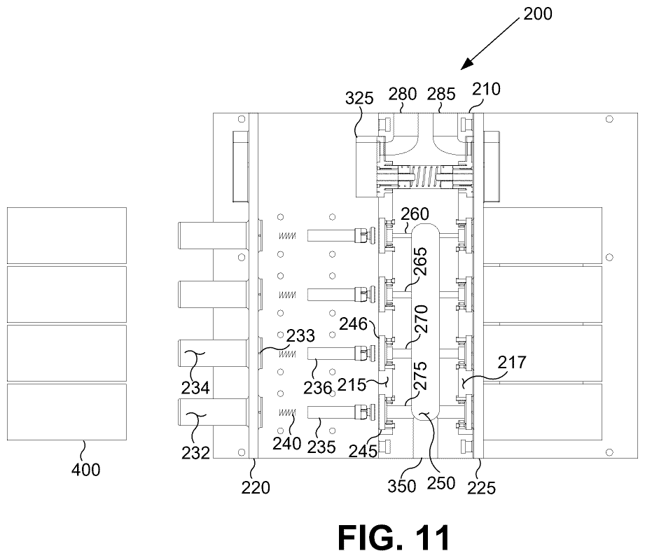

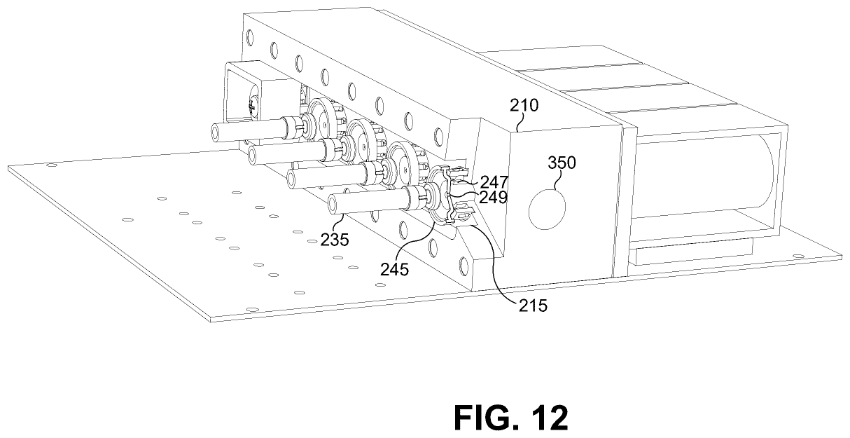

FIG. 10 is a perspective cutaway view of a device for controlling the flow of fluid. FIG. 11 is a top sectional view of a device for controlling the flow of fluid. FIG. 12 is a perspective cutaway view of the device for controlling the flow of fluid. As can be appreciated, a controlled fluid flow delivery device 200 comprises, according to one example embodiment, a manifold 210. In this example embodiment the manifold 210 includes a first chamber 215 which receives a first fluid.

As depicted in the figures, one embodiment the device 200 includes a first chamber 215 for receiving a first fluid, a first, first-chamber pressure equalization cavity 232, a first diaphragm 245 segregating the first chamber 215 from the first, first-chamber equalization cavity 232. Also included in this example embodiment are a second, first-chamber pressure equalization cavity 234, a second diaphragm 246 disposed to segregate the first chamber 215 from the second, first-chamber pressure equalization cavity 234 and a second first-chamber-dam that when covered by the second diaphragm 246 substantially precludes the flow of fluid from the first chamber 215 to the mixing chamber 250, which is also included in this example embodiment.

This example embodiment further includes a first striker 235 and the second striker 236. The first striker is disposed in the first, first-chamber pressure equalization cavity in a matter to apply force to the first diaphragm 245 so as to preclude the flow of liquid flowing over the first, first-chamber-dam in the second striker 236 is disposed within the second, first-chamber pressure equalization cavity so as to apply force to the second diaphragm 246 in order to substantially preclude flow of fluid from the first chamber 215 over the second, first-chamber dam.

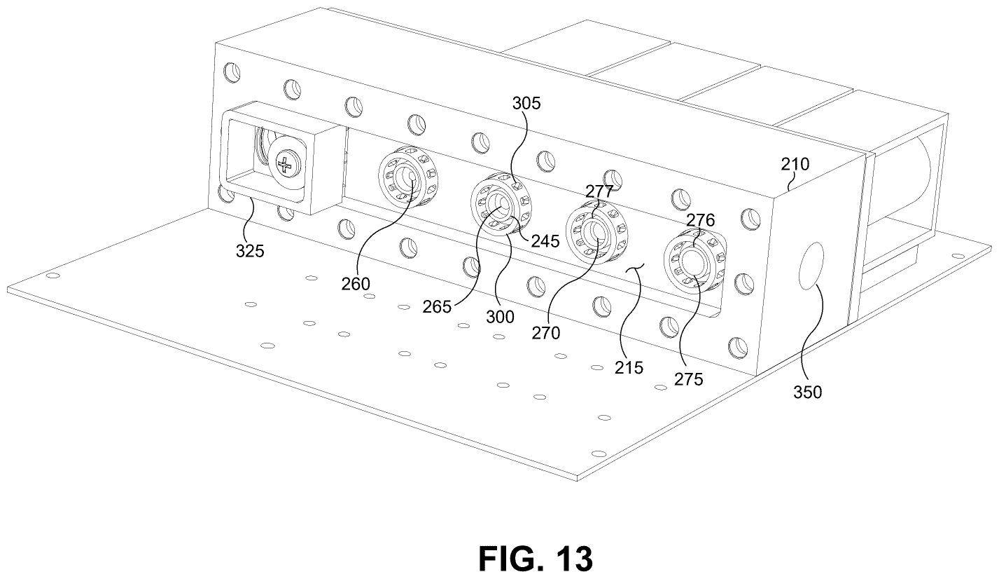

Each pressure equalization cavity 232 has included therein a striker assembly 235. The striker assembly 235 is spring-loaded 249 such that it presses against a diaphragm 245. As shown in other figures herein, the diaphragm, when subject to the force applied by the striker 235, covers a dam (245 in FIG. 13). When the diaphragm is forced against the dam, it substantially precludes water from flowing from the first chamber 215 across the dam 245 and into a mixing chamber, 250 in FIG. 12.

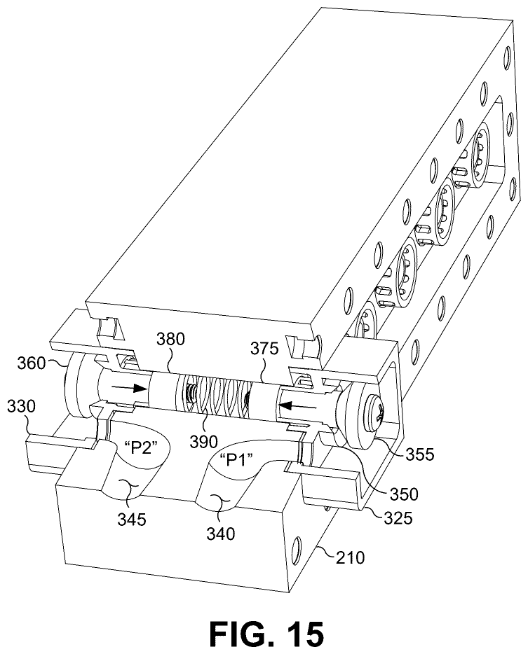

It should be noted that the device herein presented is substantially symmetric about the manifold 210. A second chamber (217 in FIG. 13) receives water at the second temperature. In this embodiment, a first striker sleeve 220 and a second striker sleeve 225 are included. It should be appreciated that each striker sleeve includes one or more pressure equalization cavities (232 in FIG. 15).

With this symmetry in mind, a corresponding striker 235 covers the dam associated with the second chamber 217. It should likewise be noted that, according this alternative example embodiment, there are a plurality of such dams associated with the first chamber 215 and a plurality of such town was associated with the second chamber 217.

FIG. 11 also shows the symmetry of the first chamber 215 relative to the second chamber 217, which each straddle a mixing chamber 250 included in the manifold 210. Each dam in the first chamber 215 has substantially concentrically within it a port which allows water to flow into the mixing chamber 251 when the dam is not covered by an associated diaphragm 245. Accordingly, each of such dam as an associated diaphragm and each such diaphragm separates the first chamber 215 from a corresponding pressure equalization cavity 232. The same structure is evident with respect to the second chamber 217 as shown in this figure and in FIG. 15.

FIG. 13 is a pictorial diagram that illustrates the sizing of the various ports which allow flow from an input chamber into the mixing chamber. As heretofore described, a first chamber 215 receives a first fluid and a second chamber 217 receives a second fluid. In one alternative example embodiment, the ports (260, 265, 270, and 275) are sized to enable a different flow rates from the first chamber 215 into the mixing chamber 250, which is shown in FIG. 12. Ports leading from the second chamber 217, again as shown in FIG. 12, likewise sized different flow rates of the second fluid from the second chamber 217 into the mixing chamber 250. Accordingly, in one alternative example embodiment the cross-section of these ports are substantially size in binary multiples of each other. For example, port 265 will have a cross-section substantially equal to twice that of the cross-section of port 260. Likewise, port 270 will have a cross-section substantially equal to twice that of the cross-section of port 265. It follows that port 275 will have a cross-section substantially equal to twice that of the cross-section of port 270. Ports leading from the second chamber 217 into the mixing chamber 250 are likewise similarly sized.

FIG. 12 also shows that each pressure equalization cavity 232 includes a pilot hole 233. The pilot hole 233 allows water from the main chamber (215 or 217) to fill the pressure equalization cavity 232. Accordingly, the pressure on each side of a diaphragm 245 is substantially equal so long as the striker 235 is holding the diaphragm 245 against the dam 247 as shown in FIG. 13.

FIG. 12 also shows that each diaphragm 245 includes a drainage path 249. When the striker 235 is applying force to the diaphragm 245 in order to compress the diaphragm 245 against the top edge of the dam 247, the striker 235 also covers this drainage path 249. Accordingly, in this state, very little force is necessary to hold the diaphragm in a closed position, i.e. having the diaphragm compressed against the top of the dam 247. It should be noted that an egress port 350 is provided to allow water from the mixing chamber 250 a path outward from the device to a delivery point.

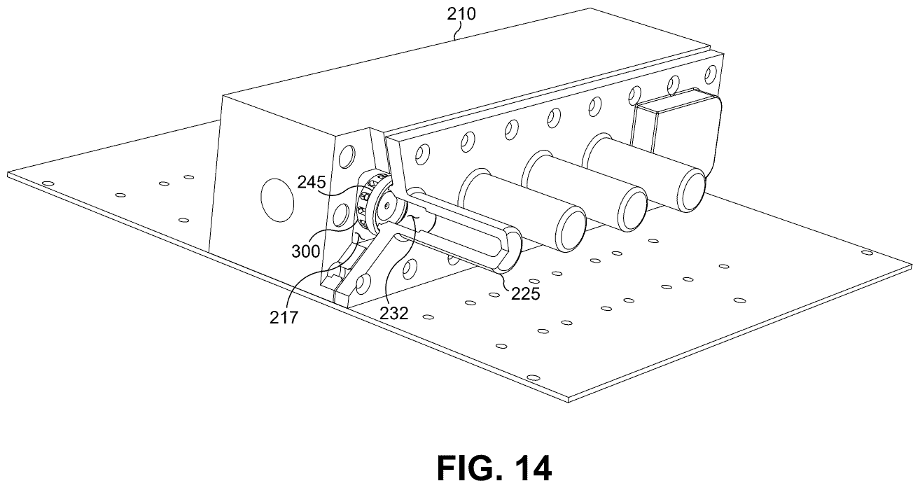

FIG. 14 is a pictorial diagram that further illustrates the structure of a pressure equalization cavity relative to an input chamber. As depicted in this figure, the manifold 210 includes an input chamber 217 which receives a second fluid. As shown in FIG. 13, the first chamber 215, which is symmetric with the second chamber 217, it is clear that the input chamber 215 provides fluid to all of the ports (260, 265, 270, and 275). In order to accomplish digital control, each dam 247 is covered by a diaphragm 245. In order to support the diaphragm above the dam, each diaphragm 245 is positioned on a circular support 300. Each such circular support 300 includes a plurality of orifices 305, which allow fluid from the chamber (215 or 217) to make its way underneath the diaphragm where it can eventually spill over a corresponding dam 247. In one alternative example embodiment, these circular supports 300 are fabricated with a plastic injection molding process and are fixed into a groove disposed in the manifold 210 using an adhesive.

FIG. 15 is a cutaway view of a pressure equalization device included in one alternative example embodiment of the device for controlling the flow of fluid. The pressure equalization device is best described as a pair of cross coupled pressure regulators. In this alternative example embodiment, a first fluid inlet 340 receives fluid at a first pressure (e.g. P1). A second fluid inlet 345 receives fluid at a second pressure (e.g. P2). When the system is dry, in other words there is no fluid flowing through either inlet, a spring 390 a first included poppet valve 355 and a second included poppet valve 360 in an open states. As fluid enters the first inlet 340 at a first pressure P1, the open poppet valve 355 allows the fluid to impart a force on a first piston 375. This first piston, based upon the force applied thereto, will drive the first poppet valve 355 closed when the pressure P1 exceeds a minimum pressure as established by the spring constant associated with the spring 390.

When second fluid enters the second inlet 345 at a second pressure P2, the second poppet valve 360, being in an open state, allows the fluid from the second inlet 345 to apply a force to a second piston 380. In the event that the pressure P2 is greater than the pressure of P1, the second poppet valve 360 will also become close, but the pressure at which the second poppet valve 360 closes will also force the first poppet valve 355 to open allowing fluid from the first inlet 342 again adjust the force applied to the first piston 375. In this manner, the regulation scheme will allow both poppet valves to regulate to the minimum pressure between P1 and P2. Accordingly, if the pressure P2 is greater than that of P1, the force applied to the first piston 375 will be transferred to the second piston 380 thus ensuring that the poppet valve 360 will only open to the same pressure present at the first inlet 340 (i.e. P1). Low

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for controlling fluid flow comprising:
receiving a first fluid into a first chamber;
forming a first first-chamber pressure equalization cavity by isolating said pressure equalization cavity from the first chamber with a first diaphragm;
allowing fluid from the first chamber to flow over a first first-chamber-dam into a mixing chamber;
forming a second first-chamber pressure equalization cavity by isolating said pressure equalization cavity from the first chamber with a second diaphragm; and
allowing fluid from the first chamber to flow over a second first-chamber-dam into the mixing chamber.

2. The method of claim 1 wherein the first first-chamber-dam allows a flow of first fluid into the mixing chamber that is a multiple of the amount of first fluid allowed to flow into the mixing chamber by the second first-chamber-dam.

3. The method of claim 1 further comprising:
receiving a second fluid into a second chamber;
forming a first second-chamber pressure equalization cavity by isolating said pressure equalization cavity from the second chamber with a third diaphragm;
allowing fluid from the second chamber to flow over a first second-chamber-dam into the mixing chamber;
forming a second second-chamber pressure equalization cavity by isolating said pressure equalization cavity from the second chamber with a forth diaphragm; and
allowing fluid from the second chamber to flow over a second second-chamber-dam into the mixing chamber.

4. The method of claim 3 wherein the first second-chamber-dam allows a flow of second fluid into the mixing chamber that is a multiple of the amount of second fluid allowed to flow into the mixing chamber by the second second-chamber-dam.

5. The method of claim 1 wherein allowing fluid to spill over a first first-chamber-dam comprises:
applying a magnetic field to retract a striker that is covering a drainage path from a pressure equalization cavity to the mixing chamber; and
allowing the fluid flow through the drainage path from a pressure equalization cavity to the mixing chamber when the striker is retracted.

6. The method of claim 5 wherein applying a magnetic field to retract a striker comprises providing a fluid barrier between the striker and an electromagnetic coil; and allowing an electric current to flow through the electromagnetic coil.

7. The method of claim 1 wherein allowing fluid to flow over a first first-chamber-dam comprises:
opening a drainage path from the first first-chamber pressure equalization cavity to the mixing chamber;
allowing the fluid in the first-chamber to deflect the first diaphragm covering a first first-chamber-dam as the pressure in the first first-chamber pressure equalization cavity is reduced; and
allowing the first fluid to flow across the first first-chamber dam as the first diaphragm is deflected.

8. The method of claim 7 further comprising:
receiving fluid from the first-chamber into the first first-chamber pressure equalization cavity at a rate so as to reduce the pressure gradient between the first-chamber and the first first-chamber pressure equalization cavity; and
forcing the first diaphragm into a position so as to substantially preclude the flow of first fluid from the first-chamber across the first first-chamber dam.

9. The method of claim 3 wherein receiving a first fluid into a first chamber and receiving a second fluid into a second chamber comprises:
receiving the first fluid from a first input source at a first pressure;
receiving the second fluid from a second input source at a second pressure;
applying the pressure of the first fluid to a first piston and applying the pressure of the second fluid to a second piston, where the first and second pistons operate in substantially opposite directions;
transferring the force from the first piston to the second piston as an opposing force and the force from the second piston to the first piston as an opposing force while applying a uniform offset to each of said forces;
controlling the flow of the first fluid from the first input to the first chamber according to the movement of the first piston; and
controlling the flow of the second fluid from the second input to the second chamber according to the movement of the second piston.

10. A controlled fluid delivery device comprising:
first chamber for receiving a first fluid;
first first-chamber pressure equalization cavity;
first diaphragm segregating the first chamber and the first first-chamber pressure equalization cavity;
first first-chamber-dam that when covered by the first diaphragm substantially precludes the flow of fluid from the first chamber to an included mixing chamber;
first striker disposed in the first first-chamber pressure equalization cavity that applies a force to the first diaphragm to substantially preclude fluid from flowing over the first first-chamber-dam;
second first-chamber pressure equalization cavity;
second diaphragm segregating the first chamber and the second first-chamber pressure equalization cavity;
second first-chamber-dam that when covered by the second diaphragm substantially precludes the flow of fluid from the first chamber to the mixing chamber; and
second striker disposed in the second first-chamber pressure equalization cavity that applies a force to the second diaphragm to preclude fluid from flowing over the second first-chamber-dam.

11. The device of claim 10 wherein the volume of fluid flowing over the second first-chamber-dam into the mixing chamber is a multiple of the amount of fluid flowing into the mixing chamber that is flowing over the first first-chamber-dam.

12. The device of claim 10 further comprising:
second chamber for receiving a second fluid;
first second-chamber pressure equalization cavity;
third diaphragm segregating the second chamber and the first second-chamber pressure equalization cavity;
first second-chamber-dam that when covered by the third diaphragm substantially precludes the flow of fluid from the second chamber to the mixing chamber;
third striker disposed in the first second-chamber pressure equalization cavity that applies a force to the third diaphragm to substantially preclude fluid from flowing over the first second-chamber-dam;
second second-chamber pressure equalization cavity;
fourth diaphragm segregating the second chamber and the second second-chamber pressure equalization cavity;
second second-chamber-dam that when covered by the fourth diaphragm substantially precludes the flow of fluid from the second chamber to the mixing chamber; and
fourth striker disposed in the second second-chamber pressure equalization cavity that applies a force to the forth diaphragm to preclude fluid from flowing over the second second-chamber-dam.

13. The device of claim 12 wherein the volume of fluid flowing over the second second-chamber-dam into the mixing chamber is a multiple of the amount of fluid flowing into the mixing chamber that is flowing over the first second-chamber-dam.

14. The device of claim 10 further comprising a first magnetic coil disposed to retract the first striker from the first diaphragm and a second magnetic coil disposed to retract the second striker from the second diaphragm.

15. The device of claim 10 wherein the first diaphragm includes a drainage path that, when not covered by the first striker, allows fluid from the first first-chamber pressure equalization cavity to drain into the mixing chamber.

16. The device of claim 10 further comprising a path for allowing fluid from the first chamber to flow into the first first-chamber pressure equalization cavity at a rate less than that of a rate allowed by a drainage path included in the first diaphragm for fluid to flow from the first first-chamber pressure equalization cavity into the mixing chamber.

17. The device of claim 12 further comprising a cross-coupled pressure regulator disposed to substantially equalize the pressure in the first and second chamber wherein said cross-coupled pressure regulator comprises:
first inlet for receiving fluid at a first pressure into a first spillway;
second inlet for receiving fluid at a second pressure into a second spillway;
first stopper for substantially preventing fluid from the first spillway from entering the first chamber;
second stopper for substantially preventing fluid from the second spillway from
entering the second chamber;
first piston situated in a cylinder and coupled to the first stopper;
second piston situated in the cylinder and coupled to the second stopper and wherein the pressure of the fluid entering the first spillway is applied to the first piston and the pressure of the fluid entering the second spillway is applied to the second piston and wherein the two pistons are mechanically coupled to equalize the pressure entering the first and second chambers.
